(19) United States
(12) Patent Application Publication
(10) Pub. No.: US 2015/0244299 A1
(43) Pub. Date: Aug. 27, 2015

(54) TRACKING CIRCUIT AND METHOD FOR TRACKING AN ORIENTATION OF A ROTOR OF A MOTOR DURING A LOSS OF SOURCE POWER TO A MOTOR DRIVE

(71) Applicant: EATON LIMITED, Titchfield Hampshire (GB)

(72) Inventor: Brian Pollard, Andover Hampshire (GB)

(21) Appl. No.: 14/422,366

(22) PCT Filed: Oct. 10, 2013
(86) PCT No.: PCT/EP2013/071210

§ 371 Date: Feb. 19, 2015

(30) Foreign Application Priority Data
Oct. 25, 2012 (GB) 1219192.0

(51) Int. Cl. H02P 23/14

(52) U.S. Cl. CPC H02P 23/14

(57) ABSTRACT

A tracking circuit for tracking an orientation of a motor rotor during a loss of source power to a motor drive includes an electrical energy store for generating a drive signal during periods of source power loss, and a phase locked loop, which is arranged to receive as inputs the drive signal and an induced signal generated during rotor rotation during the periods of source power loss, so that drive signal variations become locked to induced signal variations. The method stores electrical energy in the store during periods of source power supply to the motor drive and generates a drive signal from the electrical energy store during periods of source power loss to the motor drive. The method may vary the drive signal in dependence of an induced signal generated by rotor rotation during a source power loss to the motor drive, to track rotor orientation.

### CROSS-REFERENCE TO RELATED APPLICATIONS

This application is a U.S. National Stage application under 35 U.S.C. §371 of International Application No. PCT/EP2013/071210, filed on Oct. 10, 2013, and claims benefit to British Patent Application No. 1219192.0, filed on Oct. 25, 2012. The International Application was published in English on May 1, 2014, as WO 2014/063926 A2 under PCT Article 21(2).

### FIELD

The present invention relates to a tracking circuit and a method for tracking an orientation of a rotor of a motor during a loss of source power to a motor drive.

### BACKGROUND

Three-phase sensorless, synchronous, sine wave permanent-magnet motor drives are commonly used motor drives. With this type of motor drive, it is a requirement that the position of the rotor (on which a permanent magnet is mounted) is known by the drive in order for the three-phase drive to be correctly timed, i.e. correctly commutated. While the motor is being powered, the rotor position can be determined, using the phase relationship between the drive voltage and the drive current. This relationship is normally monitored and controlled continually, once the rotor has been “open-loop” ramped up to a suitable speed, and then becomes self-commutating.

A feature of sensorless drives however, is that they are sensitive to changes in the drive power supply. The drive power supply must be carefully matched to the motor characteristics and the motors readily stall if there are disturbances to the power supply. This is because the voltage and current must be applied to the drive in accordance with the orientation of the rotor. In a sensorless drive, only indirect evidence is available to show the rotor position. During self-commutated running of the rotor the motor drive has this information, but if there is a supply break and the rotor slows down, the drive does not know where the rotor is when power is reapplied.

If a disturbance to the power supply results in the motor stalling when the power is restored, then it is necessary to wait until the rotor has come to rest, before commencing the “open-loop” start-up procedure that these motor drives require.

In the case of aircraft fuel pumps, for example, it is desirable to provide a “hot restart”—if the power interruption is short enough, it is desirable that the motor should pick up speed again as soon as the power is reapplied, rather than waiting for the rotor to stop and then restarting.

### SUMMARY

An aspect of the invention provides a tracking circuit for tracking an orientation of a rotor of a motor during a loss of source power to a motor drive. The circuit includes: an electrical energy store configured to generate a drive signal during periods of loss of source power and a phase locked loop. The phase locked loop is configured to receive inputs including the drive signal and an induced signal generated during rotation of the rotor during the periods of loss of source power, such that variations in the drive signal become locked to variations in the induced signal.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic illustration of a multiphase motor drive arrangement comprising a tracking circuit according to an embodiment of the present invention;

FIG. 2 is a flowchart illustrating the steps associated with a method of driving a rotor of a multiphase motor according to an embodiment of the present invention comprising a method of tracking an orientation of a rotor of a motor during a loss of source power to a motor drive;

FIG. 3a is a graphical representation of the variation in phase of the drive power to the motor over a period involving a power interruption;

FIG. 3b is a graphical representation of the variation in rotor speed over a period involving a power interruption; and

FIG. 3c is a graphical representation of the variation DC control signal frequency to the VCO with time over a period involving a power interruption.

### DETAILED DESCRIPTION

According to an aspect of the present invention, there is provided a tracking circuit for tracking an orientation of a rotor of a motor during a loss of source power to a motor drive, the circuit comprising:
an electrical energy store for generating a drive signal during periods of loss of source power;
a phase locked loop, which is arranged to receive as inputs the drive signal and an induced signal generated during rotation of the rotor during the periods of loss of source power, so that variations in the drive signal become locked to variations in the induced signal.

Advantageously, the tracking circuit is arranged to track the orientation of the rotor by monitoring the induced signal generated from the continued rotation of the rotor. The induced signal is found to be linked to the orientation of the rotor and so by varying the drive signal in dependence of the variation in induced signal, then the drive signal may be applied at the time to provide for a “hot restart”, namely a restart of the drive to the rotor without first waiting for the rotor to stop rotating.

In an embodiment, the phase locked loop is arranged to lock a frequency of the drive signal to a frequency of the induced signal and in a further embodiment, the phase locked loop is arranged or further arranged to lock a phase of the drive signal to a phase of the induced signal.

Preferably, the induced signal comprises a back electromotive force (EMF) signal. The phase relationship between the motor back EMF, and the drive signal is measured by the phase-locked loop (PLL) with a type 1 phase error response (namely, with a constant drive frequency, the phase error reduces to zero). Thus, as the motor speed falls, the drive signal is made to follow it with a constant or slowly-changing phase error proportional to the rate of speed decay.

The electrical energy store may comprise a capacitor and in an embodiment, the electrical energy store or capacitor is arranged to store electrical energy during periods of drive to the rotor.

According to an aspect of the present invention, there is provided a multiphase motor drive arrangement for providing a drive to a rotor of a motor, the arrangement comprising:
a drive circuit which is electrically connectable with the motor and which is arranged to receive source power for providing rotational drive to the rotor;
a tracking circuit according to the first aspect for tracking an orientation of a rotor of the motor during a loss of source power to the drive circuit, the tracking circuit being electrically connectable to the motor; and,
a switching circuit comprising a monitor for monitoring the source power to the drive circuit, the switching circuit being arranged to switch electrical connection of the motor between the drive circuit and the tracking circuit in dependence of the monitored source power to the drive circuit.

In an embodiment, the switching circuit is arranged to monitor the level of source power to the drive circuit and switch the electrical connection of the motor from the drive circuit to the tracking circuit when the monitored level of source power to the drive circuit falls below a threshold value. The switching circuit is further arranged to switch the electrical connection of the motor from the tracking circuit to the drive circuit when the monitored level of source power to the drive circuit rises above a or the threshold value. In this manner, the switching circuit is arranged to monitor the source power supply to the motor such that during periods of power outage, the tracking circuit can track the orientation of the rotor, so that when the power is restored, the drive frequency and phase of the drive power may be suitably matched to the orientation of the rotor to provide for a hot-restart.

In an embodiment, the drive circuit comprises a drive splitter for splitting the drive power into three drive power signals which are separated in phase by 120° or π/3 radians, to provide a 3-phase power supply to the motor.

According to an aspect of the present invention, there is provided a method of tracking an orientation of a rotor of a motor during a loss of source power to a motor drive, the method comprising the steps of:
storing electrical energy in an electrical energy store during periods of source power supply to the motor drive;
generating a drive signal using the electrical energy from the electrical energy store during periods of loss of source power to the motor drive;
varying the drive signal in dependence of an induced signal generated by the rotation of the rotor during a loss of source power to the motor drive.

The method preferably comprises providing the drive signal and the induced signal as input to a phased locked loop, so that a frequency and possibly a phase of the drive signal tracks the frequency and possibly the phase of the induced signal.

According to a fourth aspect of the present invention, there is provided a method of driving a rotor of a multiphase motor, the method comprising the steps of:
monitoring a source power supply to a drive circuit which is arranged to drive the rotor of the motor;
switching electrical connection of the motor between the drive circuit and a tracking circuit for tracking an orientation of the rotor of the motor during a loss of source power to the drive circuit in accordance with the method of the second aspect, in dependence of the monitored source power supply.

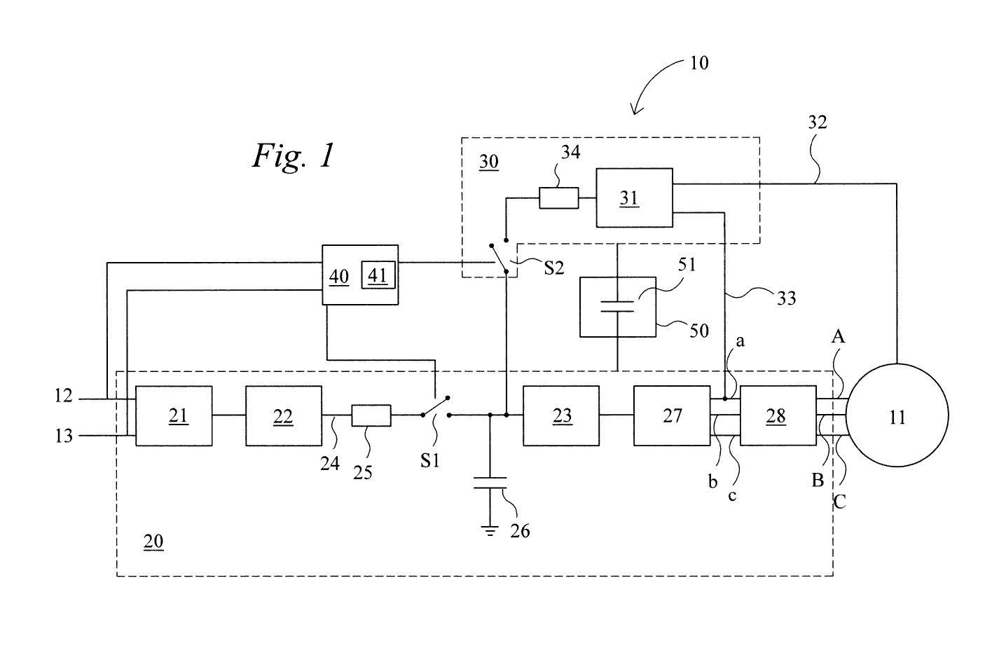

Referring to FIG. 1 of the drawings, there is illustrated a schematic illustration of a multiphase motor drive arrangement 10 for driving a rotor (not shown) of a multiphase motor 11. In the illustrated embodiment, the motor 11 comprises a 3-phase motor and as such, the drive arrangement 10 comprises a 3-phase drive arrangement. The arrangement 10 comprises a drive circuit 20 for driving the motor during periods of source power supply to the drive circuit, and a tracking circuit 30 according to an embodiment of the present invention for tracking the orientation of a rotor of the motor 11 during periods of source power loss, so that when the power is restored, the drive to the rotor can recommence without first waiting for the rotor to stop rotating.

The drive circuit 20 comprises a phase comparator 21 which is arranged to receive a motor current drive and a quadrature current on separate input channels 12, 13. The comparator 21 measures the ratio of these signals and generates a phase error which is passed to a module 22 which is arranged to generate a voltage control signal for driving a voltage controlled oscillator 23. The control signal is passed to the voltage controlled oscillator (VCO) 23 along an electrical path 24 which electrically connects the module to the VCO 23. The path 24 comprises a series arrangement of a resistor 25 and a switch S1, the latter of which is arranged to selectively connect the VCO 23 to the module 22. The path 24 further comprises capacitor disposed downstream of the switch S1, in a parallel arrangement with the path 24. In the illustrated embodiment, the capacitor 26 is coupled at one side to the path 24 and at an opposite side to an electrical ground.

The VCO 23 is arranged to generate a drive frequency signal in response to the control signal from the module 22 and this drive frequency signal passed to a drive splitter 27, which is arranged to split the drive frequency signal into a drive voltage signal on three separate channels “a”, “b” and “c”, each signal being separate in phase by 120° or π/3 radians. The drive power signals are used as seed inputs to a power amplifier 28, which subsequently amplifies the drive voltage signals for driving the 3-phase motor 11 via three high power channels A, B and C.

The tracking circuit 30 comprising a phase locked loop 31, which is arranged to receive as input on a first channel 32 an induced signal, namely a scaled back electromotive force, which is generated by the rotation of the rotor during periods of loss of power to the drive circuit 20. The phase locked loop 31 is further arranged to receive as input on a second channel 33 a drive voltage signal, such as the signal on channel “a” from the drive splitter 27. The output of the phase locked loop 31 is electrically coupled to the path 24 associated with the drive circuit 20, at a position therealong which is downstream of switch S1, via a series arrangement of a further resistor 34 and a switch S2.

The drive arrangement 10 further comprises a switching circuit 40 comprising a sensor 41 for monitoring the input power signals on channels A, B and C and is arranged to selectively switch the state of switches S1 and S2 in dependence of the monitored level of input power.

The arrangement further comprises an electrical energy store 50 which is arranged to provide drive power to the electronics associated with the drive circuit 20 and the tracking circuit 30 during periods of source power loss to the motor 11, or when the levels of source power fall below a threshold value. In the illustrated embodiment, the electrical energy store 50 may comprise a capacitor 51 or a capacitor bank, which is arranged to store electrical energy during periods of source power supply to the motor 11 and which is arranged to slowly discharge to drive the electronics of the drive circuit 20 and tracking circuit for a period following an interruption of the source power supply.

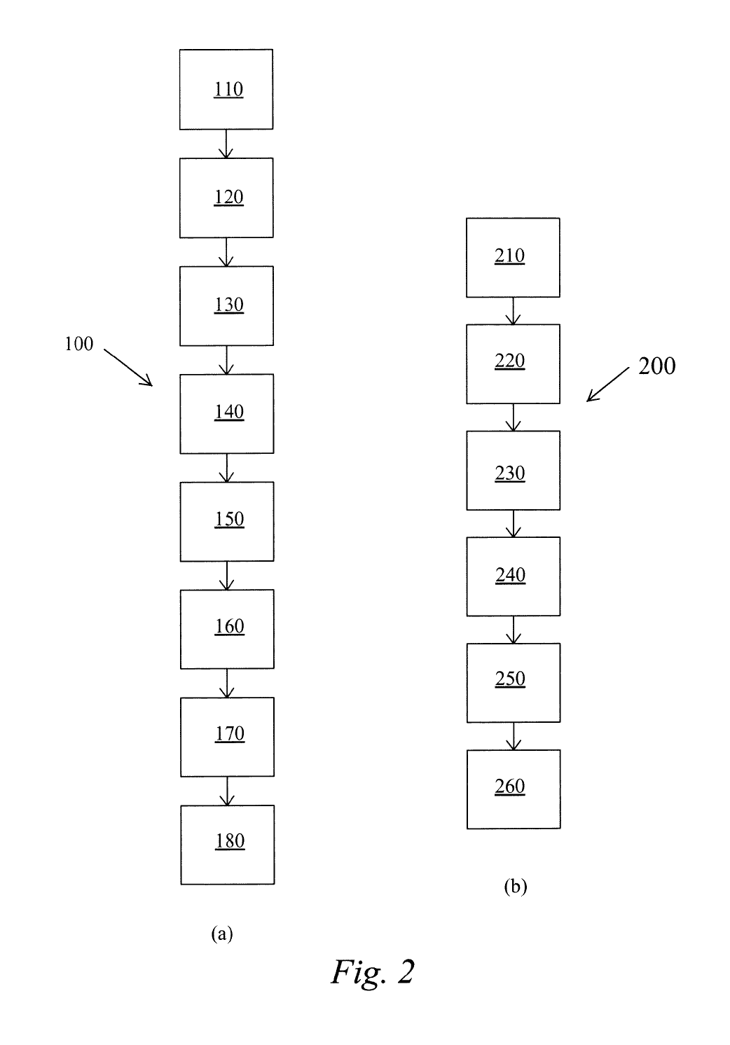

Referring to FIG. 2a of the drawings, there is illustrated a method 100 of driving a rotor of a multiphase motor. During normal drive operation of the motor 11, switch S1 is closed and switch S2 is open. The drive current signals on the input channels 12, 13 are compared at step 110 using the phase comparator 21, and the phase error signal generated by the comparator 21 is communicated to the module 22 at step 120 to generate the voltage control signal at step 130. The control signal is dependent on the phase error and is used to drive the VCO 23. During normal running, the control signal is further arranged to charge the capacitor 26 at step 140, so that electrical energy becomes stored within the capacitor 26 and the voltage on this capacitor is the control input to the VCO 23. The VCO 23 is arranged to generate a drive frequency signal at step 150 in dependence of the control signal, and this drive frequency signal is subsequently passed to the drive splitter 27 which generates the three drive power signals separated in phase by 120° or π/3 radians at step 160. These drive power signals are then amplified at step 170 by the amplifier 28 for subsequent driving of the rotor (not shown) of the motor 11 at step 180.

During the periods of source power supply to the drive circuit 20, the source power supply is further arranged to charge the electrical energy store, namely the capacitor 51 so that electrical energy becomes stored therein.

Referring to FIG. 2b of the drawings, there is illustrated steps of a method 200 according to an embodiment of the present invention for tracking an orientation of a rotor of a motor 11 during a loss of source power to the motor drive. In the event that the input power to the drive circuit 20 becomes disrupted, or in circumstances whereby the source power levels on the power channels A, B and C fall below a threshold value, then the switching circuit 40 is arranged to open switch S1 and close switch S2 at step 210 to activate the tracking circuit 30. During this switch over, the capacitor 26 provides continuity of the voltage control signal while S1 is opened and S2 is closed after which the energy from the electrical energy store 50 can continue to be used to provide a control signal to the VCO 23, to maintain the generation of the drive voltage signals at step 230. During this period of interruption to the source power supply the rotor will continue to run, albeit with a gradually reducing angular velocity and this continued rotation generates a back EMF which is passed to the phase locked loop 31, in addition to the drive power signal from channel “a” at step 240. The phase locked loop 31 subsequently generates a DC voltage on capacitor 26 which is adjusted to keep a small or zero phase difference between the back EMF and the signal on channel “a” at step 250.

The phase locked loop 31 comprises a type 1 phase error response, which is a zero-crossing phase detector whose output (a phase difference or error) is used to charge or discharge the capacitor 26 depending on whether the drive power signal phase is early or late relative to the motor back EMF. The effect of this is a feedback that actively tracks the rotor position. Furthermore, no matter how much the load or inertia changes to decrease the angular deceleration of the rotor, the rotor position will be tracked. However, it is envisaged that there is an upper limit on the maximum rate of deceleration that can be tracked, since the tracking circuit 30 requires there to be at least approximately ten cycles of rotor back EMF corresponding with the time taken for the angular speed to fall to approximately 20% of the initial speed. This is not difficult to meet in practical systems and for a rate of deceleration that exceeds this, it is unlikely that a requirement for a “hot restart” would exist. So, subject to an upper limit on the rate of rotor speed deceleration that can be tracked, the tracking circuit 30 is otherwise insensitive to the load or inertia for successful operation.

In this way, the drive frequency signal is kept in synchronism with the rotor position so that when the power is restored to the drive circuit 20 and the switching circuit 40 switches the state of switches S1 and S2 to close S1 and open S2 at step 260, the drive is switched back to its normal running configuration and the DC voltage controls the drive frequency is already at the correct level corresponding with the rotor speed, possibly with a finite static phase error.

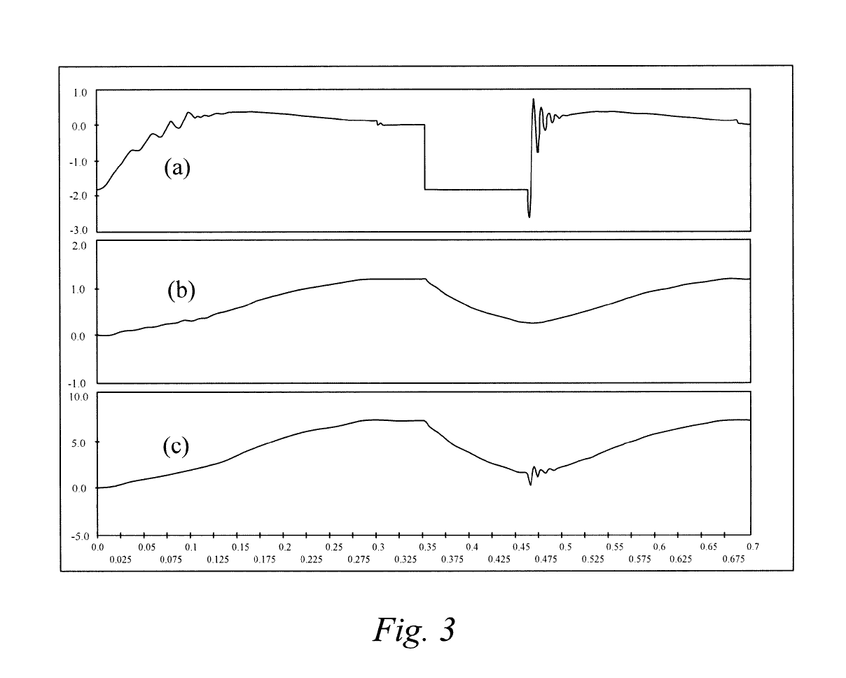

Referring to FIG. 3 of the drawings, there is illustrated a series of traces illustrating the variation in phase error, rotor angular speed and the voltage control signal over a time period involving a power loss to the drive circuit. Upon referring to FIGS. 3a-c it is evident that at a time t=0.36s, the input power to the drive circuit is removed or otherwise falls below a threshold value which causes the switching circuit 40 to open switch S1 and close switch S2, and the rotor speed starts to decrease. The control signal follows the reducing speed of the rotor, by virtue of the locking of the drive input signal “a” to the back EMF. When power is restored and the motor speed starts to rise again, there is a “splash” in the DC drive and the drive phase error but the phase error settles down.

From the foregoing therefore, it is evident that the drive arrangement 10 and tracking circuit 30 allows the drive to restart and achieve phase lock immediately after the input power is restored, following a loss of input power and a drop in motor speed.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A tracking circuit for tracking an orientation of a rotor of a motor during a loss of source power to a motor drive, the circuit comprising:
an electrical energy store configured to generate a drive signal during periods of loss of source power; and
a phase locked loop,
wherein the phase locked loop is configured to receive inputs including the drive signal and an induced signal generated during rotation of the rotor during the periods of foss of source power, such that variations in the drive signal become locked to variations in the induced signal.

2. The tracking circuit of claim 1, wherein the phase locked loop is configured to lock a frequency of the drive signal to a frequency of the induced signal.

3. The tracking circuit of claim 1, wherein the phase locked loop is configure to lock a phase of the drive signal to a phase of the induced signal.

4. The tracking circuit of claim 1, wherein the induced signal includes a back electromotive force signal.

5. The tracking circuit of claim 1, wherein the electrical energy store includes a capacitor.

6. A multiphase motor drive arrangement for providing a drive to a rotor of a motor, the arrangement comprising:
a drive circuit which is electrically connectable with the motor and which is configured to receive source power for providing rotational drive to the rotor;
the tracking circuit of claim 1 for tracking an orientation of a rotor of the motor during a loss of source power to the drive circuit, the tracking circuit being electrically connectable to the motor; and,
a switching circuit including a monitor configured to monitor a source power supply to the drive circuit, the switching circuit being configured to switch an electrical connection of the motor between the drive circuit and the tracking circuit depending upon a monitored source power to the drive circuit.

7. The arrangement of claim 6, wherein the switching circuit is configured to monitor a level of the source power to the drive circuit and switch the electrical connection of the motor from the drive circuit to the tracking circuit when a monitored level of the source power to the drive circuit falls below a threshold value.

8. The arrangement of claim 6, wherein the switching circuit is configured to switch an electrical connection of the motor from the tracking circuit to the drive circuit when a monitored level of the source power to the drive circuit rises above a threshold value.

9. The arrangement of claim 6, wherein the drive circuit includes a drive splitter configured to split the drive power into three drive power signals which are separated in phase by 120° or π/3 radians, to provide a 3-phase power supply to the motor.

10. A method of tracking an orientation of a rotor of a motor during a loss of source power to a motor drive, the method comprising:
storing electrical energy in an electrical energy store during periods of source power supply to the motor drive;
generating a drive signal using electrical energy from the electrical energy store during periods of loss of source power to the motor drive; and
varying the drive signal depending upon an induced signal generated by a rotation of the rotor during a loss of source power to the motor drive.

11. The method of claim 10, further comprising:
providing the drive signal and the induced signal as input to a phased locked loop.

12. A method of driving a rotor of a multiphase motor, the method comprising:
monitoring a source power supply to a drive circuit which is configured to drive the rotor of the motor; and
switching electrical connection of the motor between the drive circuit and a tracking circuit for tracking an orientation of the rotor of the motor during a loss of source power to the drive circuit depending upon the monitoring of the source power supply.

13. The tracking circuit of claim 2, wherein the phase locked loop is further configured to lock a phase of the drive signal to a phase of the induced signal.
